(19) United States
(12) Patent Application Publication
(10) Pub. No.: US 2022/0358600 A1
(43) Pub. Date: Nov. 10, 2022

(54) AGGREGATING INFORMATION FROM GIG ECONOMY PLATFORMS FOR ANALYSIS BY MACHINE LEARNING MODELS

(71) Applicant: Capital One Services, LLC, McLean, VA (US)

(72) Inventors: Xiaoguang Zhu, Great Neck, NY (US); Abdelkader M'Hamed Benkreira, Brooklyn, NY (US); Phoebe Atkins, Rockville, VA (US); Shabnam Kousha, Washington, DC (US)

(21) Appl. No.: 17/314,181

(22) Filed: May 7, 2021

(51) Int. Cl. G06Q 40/00; H04L 29/06; G06N 20/00; G06N 5/04; G06Q 30/02

(52) U.S. Cl. CPC G06Q 40/12; H04L 63/083; G06N 20/00; G06N 5/04; G06Q 30/0282

(57) ABSTRACT

The present disclosure describes aggregating information from one or more gig economy platforms. A data aggregator may receive an indication that a user has worked for one or more gig economy platforms. The indication may include the user's login credentials. The data aggregator may then use the login credentials to retrieve user information from each of the one or more gig economy platforms. The server may aggregate and normalize the user information, such that the information may be presented to the user in a consumable format. Additionally, the user information may be used to render decisions and/or make determinations about the user based on the user's employment records associated with the one or more gig economy platforms.

### FIELD OF USE

Aspects of the disclosure relate generally to aggregating data and/or information and, more specifically to aggregating information from gig economy platforms.

### BACKGROUND

Short-term contractual and/or freelance work, commonly referred to as gig economy jobs, are becoming more prevalent. For instance, workers sign-up with one or more gig economy platforms, such as a ride-sharing service (e.g., Uber, Lyft, etc.) or a food delivery service (e.g., DoorDash, Postmates, etc.), and begin earning income. However, the contractual nature of the work, and the uncertainty surrounding various aspects of the work, makes it difficult to track earnings, hours worked, employment records, accolades, complaints etc., for example, when a user needs to verify their employment. Moreover, working for multiple gig economy platforms further complicates the user's employment records.

### SUMMARY

The following presents a simplified summary of various features described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

The methods, devices, systems, and/or computer-readable media described herein provide for a data aggregator to obtain user information from one or more gig economy platforms. A user may identify each of the one or more gig economy platforms that he/she has worked for. Additionally, the user may provide login credentials to a server with an indication that he/she wants to aggregate their information from each of the one or more gig economy platforms. After receiving the login credentials, the server may retrieve the user information from each of the one or more gig economy platforms. The server may aggregate and normalize the user information, such that the information may be presented to the user in a consumable format. Additionally, the user information may be used to render decisions and/or make determinations about the user.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a system in which one or more features described herein may be implemented according to one or more aspects of the disclosure;

FIG. 2 shows an example computing device according to one or more aspects of the disclosure;

FIG. 3 shows a flow chart of a process for aggregating data from one or more gig economy platforms according to one or more aspects of the disclosure; and

FIG. 4 shows a flow chart of a process for predicting an earning potential for a user that earns at least part of their income via a gig economy platform according to one or more aspects of the disclosure.

### DETAILED DESCRIPTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, features discussed herein may relate to methods, devices, systems, and/or computer-readable media for aggregating information from one or more gig economy platforms. As noted above, a user earning income from one or more gig economy platforms may create uncertainty about the user's earning potential, earning durability, etc. Moreover, it may be difficult to verify employment for a user working for one or more gig economy platforms. Accordingly, aggregating a user's information from one or more gig economy platforms may create a repository of the user's employment information which may be used, for example, to render decisions about the user and/or their earning potential, credit history, credit score, employment verification, etc.

The present disclosure describes a data aggregator that may obtain user information from one or more gig economy platforms. In this regard, a user may indicate one or more gig economy platforms for which he/she has worked. Additionally, the user may provide login credentials, along with the indication of the one or more gig economy platforms. In response to receive the indication of one or more gig economy platforms and/or the login credentials, the data aggregator may gather user information from each of the one or more gig economy platforms. The user information may be normalized and presented to the user. According to some aspects of the disclosure, the user information from the one or more gig economy platforms may be used to determine earning potential, credit history, credit score, employment verification, etc. In some examples, the aggregator may be associated with a financial institution, such as a bank. The financial institution may use the aggregator to obtain and/or verify employment information associated with the user. Additionally, the financial institution may use the employment information to make decisions about the user's creditworthiness (e.g., credit score). For example, the user may request a financial product, such as a personal loan, an auto loan, a mortgage, etc. In order to render a decision about the request, the aggregator may obtain update user information from the one or more gig economy platforms. The updated user information may be analyzed for example, using automated analysis, to identify at least one of the user's name, address, income, hours worked, employment history, competitiveness of the user, and/or a customer rating of the user. A first machine learning model may be used to determine one or more trends associated with the one or more gig economy platforms. Next, an earning potential for the user may be calculated, for example, based on the user's income, hours worked, the employment history, and/or the one or more trends. Additionally, a second machine learning model may be used to calculate an earning durability of the user. The earning durability may be based on at least one of the competitiveness of the user and/or the customer rating of the user. Based on the earning potential and the earning durability rating, an aggregate score may be determined. When the aggregate score satisfies a threshold, the user may be approved for the financial product and a notification may be sent to the user. When the aggregate score fails to satisfy the threshold, the user may be denied, and an appropriate notification may be sent to the user. In this regard, the information aggregated from the one or more gig economy platforms may be used to provide more accurate information, for example, when rendering a determination about the user and/or their employment verification.

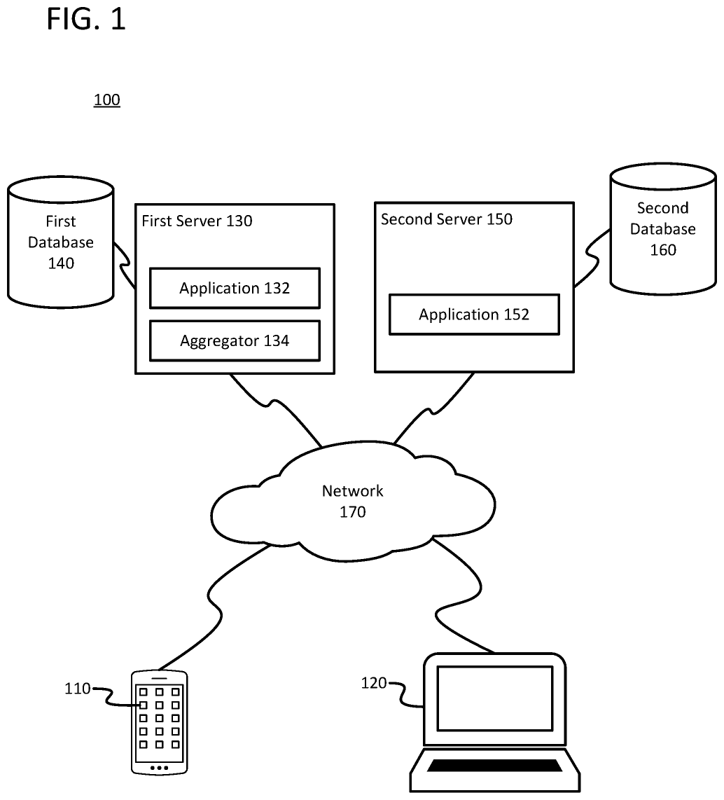

FIG. 1 shows an example of a system 100 that comprises a first client device 110, a second client device 120, a first server 130, connected to a first database 140, and a second server 150, connected to a second database 160, all interconnected via network 170.

First client device 110 may be a mobile device, such as a cellular phone, a mobile phone, a smart phone, a tablet, a laptop, or an equivalent thereof. First client device 110 may provide a first user with access to various applications and services. For example, first client device 110 may provide the first user with access to the Internet. Additionally, first client device 110 may provide the first user with one or more applications (“apps”) located thereon. The one or more applications may provide the first user with a plurality of tools and access to a variety of services. In some embodiments, the one or more applications may include a banking application that provides access to the first user's banking information, as well as perform routine banking functions, such as checking the first user's balance, paying bills, transferring money between accounts, withdrawing money from an automated teller machine (ATM), wire transfers, and/or applying for financial product, such as loans and investment accounts. Additionally or alternatively, the one or more applications may comprise a client-side gig economy application that allows a user of the first client device 110 to earn income via the client-side gig economy application.

Second client device 120 may be a computing device configured to allow a user to execute software for a variety of purposes. Second client device 120 may belong to the first user that accesses first client device 110, or, alternatively, second client device 120 may belong to a second user, different from the first user. Second client device 120 may be a desktop computer, laptop computer, or, alternatively, a virtual computer. The software of second client device 120 may include one or more web browsers that provide access to websites on the Internet. These websites may include banking websites that allow the user to access his/her banking information and perform routine banking functions. In some embodiments, second client device 120 may include a banking application that allows the user to access his/her banking information and perform routine banking functions, such as applying for financial products (e.g., loans, investment accounts, etc.).

First server 130 may be any type of server, such as a stand-alone server, a corporate server, or a server located in a server farm or cloud-computer environment. According to some examples, the first server 130 may be a virtual server hosted on hardware capable of supporting a plurality of virtual servers. The first server 130 may comprise an application 132 and/or a data aggregator 134. Additionally, the first server 130 may be communicatively coupled to a first database 140.

The application 132 may be server-based software configured to provide users with access via corresponding client-side software. For example, the application 132 may be a server-side banking application that provides users with access to their account information and/or perform routing banking functions via a client-side application executing on a client device. Additionally, or alternatively, the application 132 may provide users access to their account information through a website accessed by first client device 110 or second client device 120 via network 170. In some examples, the application 132 may comprise an authentication module to verify users before granting access to their account information.

The aggregator 134 may also be server-based software configured to retrieve information from one or more sources. The one or more sources may comprise one or more gig economy platforms. The aggregator 134 may comprise one or more application programming interfaces (APIs) configured to retrieve information from the one or more gig economy platforms. In some instances, the aggregator 134 may be a third-party API, such as one provided by Plaid, Finicity, Argyle, or an equivalent thereof. Additionally or alternatively, the aggregator 134 may use a scraping algorithm to obtain the information from the one or more gig economy platforms. The aggregator 134 may use login credentials to retrieve information from the one or more gig economy platforms. The login credentials may comprise a user's username and password. Additionally or alternatively, the login credentials may comprise at least one of: an API key, a tokenized version of login credentials, a certificate, a token, or any other suitable authentication credential. The aggregator 134 may be configured to retrieve the information from the one or more gig economy platforms periodically (e.g., hourly, daily, weekly, bi-weekly, monthly, quarterly, semi-annually, etc.). The information may comprise profile information that includes at least one of a name of the user, an address of the user, an income of the user, hours worked by the user, employment history of the user, competitiveness of the user, and/or a customer rating of the user.

First database 140 may be configured to store information on behalf of application 132. The information may include, but is not limited to, personal information, employment information, account information, user-preferences. Personal information may include a user's name, address, phone number (i.e., mobile number, home number, business number, etc.), social security number, username, password, employment information, family information, and any other information that may be used to identify the first user. The employment information may comprise the profile information obtained from the one or more gig economy platforms. Account information may include account balances, bill pay information, direct deposit information, wire transfer information, statements, and the like. User-preferences may define how users receive notifications and alerts, spending notifications, and the like. First database 140 may include, but is not limited to relational databases, hierarchical databases, distributed databases, in-memory databases, flat file databases, XML databases, NoSQL databases, graph databases, and/or a combination thereof.

Second server 150 may be any type of server, such as a stand-alone server, a corporate server, or a server located in a server farm or cloud-computer environment. According to some examples, the second server 150 may be a virtual server hosted on hardware capable of supporting a plurality of virtual servers. The second server may be associated with a gig economy platform, such as a ride sharing service; a food delivery service; a pet sitting service; a personal shopper service, a courier delivery service; a moving service; a task completion service; or a cleaning service. The second server 150 may comprise an application 152 configured to allow users to earn an income by performing various tasks and/or functions. Additionally, the second server 150 may be communicatively coupled to a second database 150.

The application 152 may be server-based software configured to provide users with access via corresponding client-side software. For example, the application 152 may be a server-side application associated with a gig economy platform. That is, the application 152 may correspond to a client-side application that allows users to earn an income, for example, in response to performing tasks and/or services. In this regard, the application 152 may provide users access to their account information. The account information may comprise the user's name, address, income, hours worked, employment history, competitiveness ranking, and/or customer rating. In some examples, the application 152 may comprise an authentication module to verify users before granting access to their account information.

The second database 160 may be configured to store information on behalf of application 152. The information may include, but is not limited to, a name of the user, an address of the user, an income the user has earned, hours the user has worked, employment history of the user, competitiveness of the user, and/or a customer rating of the user. The second database 160 may include, but is not limited to relational databases, hierarchical databases, distributed databases, in-memory databases, flat file databases, XML databases, NoSQL databases, graph databases, and/or a combination thereof. While FIG. 1 shows one server (i.e., the second server 150) and one database (i.e., the second database 160) associated with a gig economy platform, it will be appreciated that system 100 may comprise any number of servers and/or databases associated with a plurality of gig economy platforms.

First network 170 may include any type of network. In this regard, first network 150 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

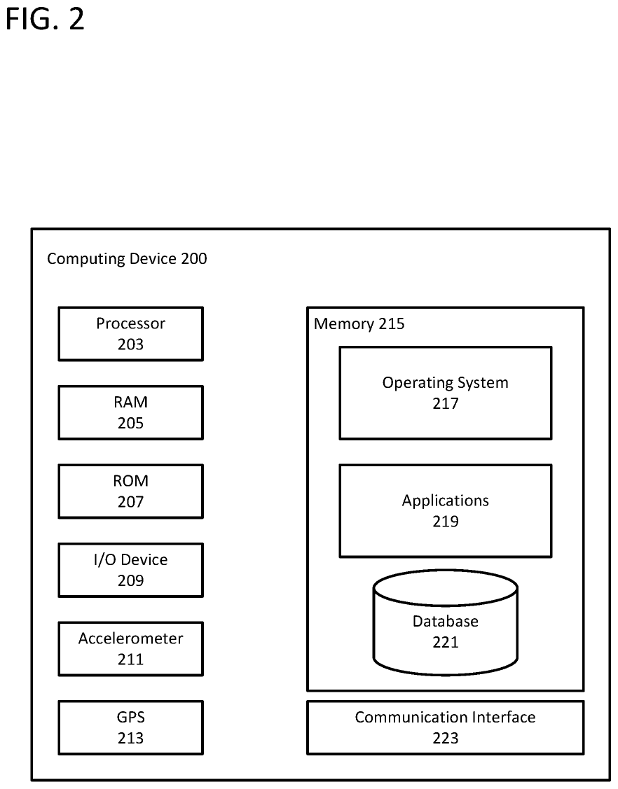

Any of the devices and systems described herein may be implemented, in whole or in part, using one or more computing devices described with respect to FIG. 2. Turning now to FIG. 2, a computing device 200 that may be used with one or more of the computational systems is described. The computing device 200 may comprise a processor 203 for controlling overall operation of the computing device 200 and its associated components, including RAM 205, ROM 207, input/output device 209, accelerometer 211, global-position system antenna 213, memory 215, and/or communication interface 223. A bus 202 may interconnect processor(s) 203, RAM 205, ROM 207, memory 215, I/O device 209, accelerometer 211, global-position system receiver/antenna 213, memory 215, and/or communication interface 223. Computing device 200 may represent, be incorporated in, and/or comprise various devices such as a desktop computer, a computer server, a gateway, a mobile device, such as a laptop computer, a tablet computer, a smart phone, any other types of mobile computing devices, and the like, and/or any other type of data processing device.

Input/output (I/O) device 209 may comprise a microphone, keypad, touch screen, and/or stylus through which a user of the computing device 200 may provide input, and may also comprise one or more of a speaker for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may comprise volatile and nonvolatile, removable and non-removable media implemented in any method or technology for storage of information such as computer-readable instructions, data structures, program modules, or other data. Memory 215 may comprise one or more physical persistent memory devices and/or one or more non-persistent memory devices. Memory 215 may comprise random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Accelerometer 211 may be a sensor configured to measure accelerating forces of computing device 200. Accelerometer 211 may be an electromechanical device. Accelerometer may be used to measure the tilting motion and/or orientation computing device 200, movement of computing device 200, and/or vibrations of computing device 200. The acceleration forces may be transmitted to the processor to process the acceleration forces and determine the state of computing device 200.

GPS receiver/antenna 213 may be configured to receive one or more signals from one or more global positioning satellites to determine a geographic location of computing device 200. The geographic location provided by GPS receiver/antenna 213 may be used for navigation, tracking, and positioning applications. In this regard, the geographic may also include places and routes frequented by the first user.

Communication interface 223 may comprise one or more transceivers, digital signal processors, and/or additional circuitry and software, protocol stack, and/or network stack for communicating via any network, wired or wireless, using any protocol as described herein.

Processor 203 may comprise a single central processing unit (CPU), which may be a single-core or multi-core processor, or may comprise multiple CPUs. Processor(s) 203 and associated components may allow the computing device 200 to execute a series of computer-readable instructions (e.g., instructions stored in RAM 205, ROM 207, memory 215, and/or other memory of computing device 215, and/or in other memory) to perform some or all of the processes described herein. Although not shown in FIG. 2, various elements within memory 215 or other components in computing device 200, may comprise one or more caches, for example, CPU caches used by the processor 203, page caches used by the operating system 217, disk caches of a hard drive, and/or database caches used to cache content from database 221. A CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

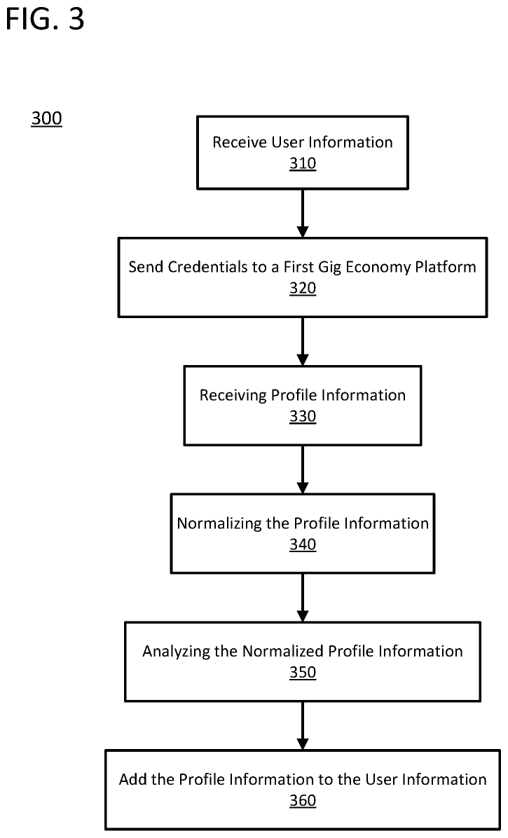

As noted above, more and more people are earning income via one or more gig economy platforms. This income may be their entire earnings. Alternatively, the income earned from one or more gig economy jobs may be to supplement their existing income. For a variety of reasons, users may have to verify their income and/or employment history, which may be difficult when income is earned via a gig economy platform. FIG. 3 shows a flow chart of a process 300 for aggregating data from one or more gig economy platforms according to one or more aspects of the disclosure. The process 300 may improve the accuracy and ease by which users can obtain their information from a gig economy platform, for example, to verify their income and/or employment history. Some or all of the steps of process 300 may be performed using one or more computing devices as described herein, including, for example, the first client device 110, the second client device 120, the first server 130, the second server 150, the computing device 200, or any combination thereof. One or more steps of the process 300 may be rearranged, omitted, and/or otherwise modified, and/or other steps may be added as appropriate.

In step 310, a computing device, such as the first server 130, may receive user information. The user information may be received, for example, as part of opening a new account with a financial institution. Additionally or alternatively, the user information may be received as part of a request for a financial product, such as a loan (e.g., auto loan, personal loan, home loan), a mortgage, an investment account, a credit card, a bond etc. The user information may comprise personal information, such as the user's name, address, social security history, education, etc. Additionally or alternatively, the user information may comprise employment information. The employment information may comprise an employer's name, address, how long the user has been employed, the user's title, the user's earnings, etc. The employment information may also indicate one or more gig economy platforms. In response to receiving an indication that the user works for one or more gig economy platforms, the computing device may request the user's credentials for the one or more gig economy platforms. The request may indicate that access to the one or more gig economy platforms may be used to verify the user's earnings (e.g., income) and/or employment history. Additionally or alternatively, the request may indicate that access to the one or more gig economy platforms may be used to determine accounts, offers, etc. for which the user may be eligible, for example, based on the user's earnings, earning potential, and/or earning durability. If the user provides access to the one or more gig economy platforms, the user may provide login credentials for each of the one or more gig economy platforms. The login credentials may comprise a username and password. Additionally or alternatively, the login credentials may comprise one or more of: an API key, a tokenized version of login credentials, a certificate, a token, or any other suitable authentication credential.

In step 320, the computing device may send the login credentials to one or more gig economy platforms. As discussed above, the login credentials may be provided to the one or more gig economy platforms to verify earnings (e.g., income) and/or employment history. An application executing on the computing device, such as the data aggregator 134 discussed with respect to FIG. 1, may send the login credentials to one or more gig economy platforms, such as one of the gig economy platforms discussed above with respect to the second server 150. In this regard, the computing device (e.g., the application) may interface with the one or more gig economy platforms through various APIs. That is, the computing device may comprise a first API that communicates with a second API associated with the one or more gig economy platforms. In this regard, the computing device may send a request for a user's profile to the one or more gig economy platforms. The request may comprise identification information (e.g., a username) indicating the user. Additionally, the request may also comprise the login credentials.

In step 330, the computing device may receive profile information associated with the user from the one or more gig economy platforms. The profile information may be obtained from the one or more gig economy platforms, for example, based on successful verification of the credentials. The profile information may be received as a file from the one or more gig economy platforms. Additionally or alternatively, the profile information may be received as a stream from the one or more gig economy platforms. In this regard, the profile information may be received as a continuous stream from the one or more gig economy platforms. The computing device may deserialize the stream, for example, according to a schema defined by the gig economy platform. Streaming profile information may provide better insight and/or accuracy with respect to the user's earnings, earning potential, and/or earning durability. The profile information may comprise data and/or information associated with the user. The profile information may comprise personal information and/or employment information. The computing device may parse the profile information to obtain the personal information and/or the employment information. The personal information may comprise the user's name, the user's address, and similar information. The employment information may comprise the user's income, hours worked by the user, an employment history of the user, a competitiveness of the user, and/or a customer rating of the user. The competitiveness of the user may comprise a rating and/or ranking of how the user performs compared to other users within a geographic area. The geographic area may be an operating area of the user. Additionally or alternatively, the geographic area may be a metropolitan area or defined by a predetermined radius from the user's home address (e.g., 25 miles, 50 miles, 100 miles, etc.).

In step 340, the computing device may normalize the profile information. Normalizing the profile information may comprise converting the profile information into a format usable by the computing device. Additionally or alternatively, normalizing the profile information may comprise deserializing the stream of information received from one or more gig economy platforms. In this regard, normalizing the profile information may comprise identifying one or more fields in the stream of data. The one or more fields may be identified using one or more identifier bindings.

The first computing device may analyze the normalized profile information. The analysis of the normalized profile information may be performed using automated analysis, such as natural language processing (NLP), object character recognition (OCR), computer vision, machine learning, or any combination thereof. The automated analysis may be used to identify one or more fields and/or pieces of data and/or information associated with the user's profile information. As noted above, the one or more fields may comprise employment information, such as the user's name, the user's address, the user's income, hours worked by the user, an employment history of the user, a competitiveness of the user, or a customer rating of the user. The profile information may be compared to the user information received, for example, in step 310. Additionally or alternatively, the profile information may be compared to user information already on-file with the first computing device.

In step 360, the computing device may add the profile information from the one or more gig economy platforms to the user information. In particular, the profile information may be used to complete the employment portion of the user information. Additionally or alternatively, the profile information may be used to verify the employment portion of the user information. In some instances, the user may be prompted to resolve discrepancies between the profile information received from the one or more gig economy platforms before the profile information is added to the user information. In further examples, the employment information, and additional information, such as an earning durability rating, may be used to determine what services the user is eligible to receive.

By using the data aggregator described above, the speed and/or accuracy with which employment information may be added to a user's information may be improved. Additionally, the data aggregator may remove redundant, superfluous, and/or incorrect information stored in the user information, thereby reducing the amount of memory consumed by the user information.

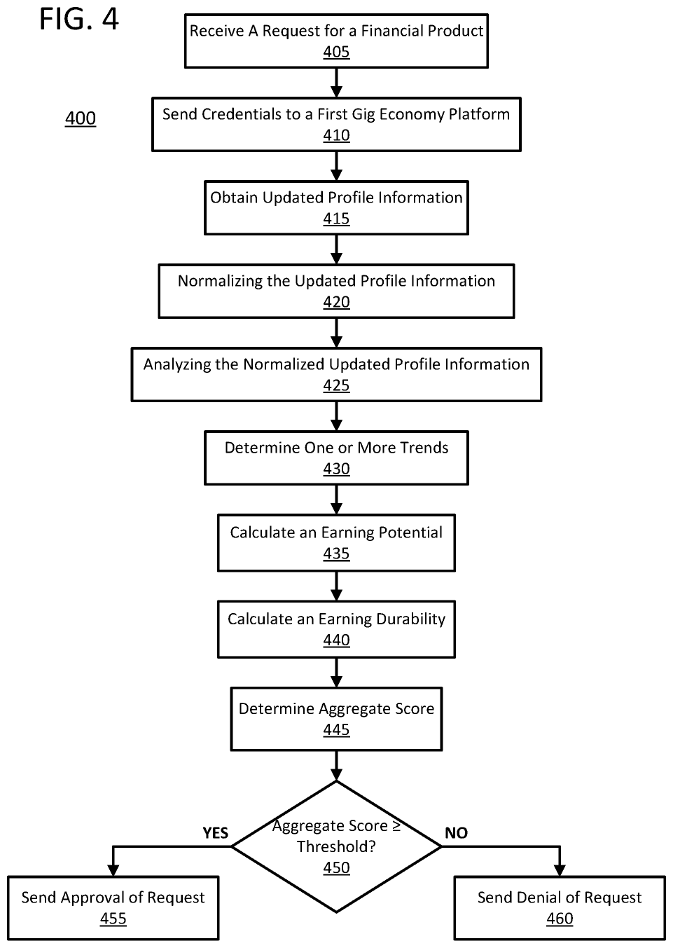

As noted above, gig economy workers may apply for financial products, such as loans, mortgages, investment accounts, etc. However, financial institutions may have a difficult time determining the user's earnings (e.g., income), earning potential, and/or earning durability based on the volatility and/or uncertain nature of gig economy work. FIG. 4 shows a flow chart of a process 400 for predicting an earning potential for a user that earns at least part of their income via a gig economy platform according to one or more aspects of the disclosure. Some or all of the steps of process 400 may be performed using one or more computing devices as described herein, including, for example, the first client device 110, the second client device 120, the first server 130, the second server 150, the computing device 200, or any combination thereof. One or more steps of the process 400 may be rearranged, omitted, and/or otherwise modified, and/or other steps may be added as appropriate.

In step 405, a computing device, such as the first server 130, may receive a request for a financial product. The request may comprise user information, such as the user information discussed above with respect to step 310 of FIG. 3. Similarly, the financial product may be one or more of a loan (e.g., auto loan, personal loan, home loan, etc.), a mortgage, an investment account, a credit card, a bond etc. As noted above, the user information may comprise employment information, which may be required as part of the request for the financial product. In order to verify the employment information, the computing device may request access to one or more gig economy platforms, for example, if the user's employment information indicates that at least a part of the user's income is earned via the one or more gig economy platforms. If the user consents to the computing device accessing the one or more gig economy platforms, the user may provide login credentials for each of the one or more gig economy platforms for which the user has earned income from. As noted above, the login credentials may comprise at least one of a username and password, an API key, a tokenized version of login credentials, a certificate, a token, or any other suitable authentication credential.

In step 410, the computing device may send the login credentials to one or more gig economy platforms. As discussed above, the computing device may send the login credentials to one or more gig economy platforms. For example, the computing device may interface with the one or more gig economy platforms through various APIs to obtain the user's profile information.

In step 415, the computing device may receive profile information associated with the user from the one or more gig economy platforms. The profile information may be obtained, for example, with the user's consent if the user is applying for a financial product and/or opening account. Additionally or alternatively, the profile information may be updated profile information. For example, the user may be an existing customer that is applying for the financial product. Accordingly, the computing device may update the profile information to obtain up-to-date information associated with the user's earnings (e.g., income), earning potential, and/or earning durability.

In some examples, the computing device may obtain additional information regarding the user. For example, the computing device, via one or more APIs, may obtaining licensing information associated with the user as part of the request for the financial product. For example, if the user indicates that he/she drives for a ride sharing service (e.g., Uber, Lyft, etc.), the computing device may request the user's driver's abstract (e.g., driving information). The driver's abstract may be provided to the computing device in a stream from a motor vehicle commission. The computing device may normalize the stream of information and analyze the driver's abstract to determine whether there are any indicators in the driver's abstract that would impact the user's earning potential. For example, if the user had a plurality of infractions that could result in their license being suspended, the plurality of infractions may negatively impact the user's earning potential. The driving information obtained from the motor vehicle commission may comprise license information, driver history, vehicle registration, a vehicle history associated with the user, etc. For example, the computing device, via one or more APIs, may obtain a lawyer's bar information from one or more licensing bodies, for instance, if the lawyer was earning income via one or more freelance websites. In this regard, the computing device may obtain whether the attorney is in good standing, or otherwise, from a state bar association.

In step 420, the computing device may normalize the profile information received from the one or more servers. As discussed with respect to FIG. 3, normalizing the profile information may comprise converting the profile information into a format usable by the computing device. This may include deserializing a stream of data and/or information received from the one or more servers.

In step 425, the first computing device may analyze the normalized profile information, for example, using NLP, OCR, computer vision, machine learning, or any combination thereof. The automated analysis may be used to identify one or more fields and/or pieces of data and/or information associated with the user's profile information, such as the user's name, the user's address, the user's income, hours worked by the user, an employment history of the user, a competitiveness of the user, or a customer rating of the user. As noted above, the analysis may be an initial read of the profile information or an updated read of the profile information for existing customers/users.

In step 430, the computing device may determine one or more trends associated with the one or more gig economy platforms. The one trends may indicate at least one of growth, stagnation, or shrinkage for the one or more gig economy platforms. In some instance, the one or more trends may be identified using a first machine learning model. The first machine learning model may be trained to review customer spending data associated with one or more gig economy platforms. The review of the customer spending data may show which industries/fields are growing, stagnating, and/or shrinking. The review of the customer spending data may show which gig economy platforms users are spending their money on. For instance, the first machine learning model may analyze the customer spend data to determine whether people are spending more money on Uber or Lyft. Additionally or alternatively, the first machine learning model may determine a concentration and/or distribution of earnings within a gig economy platform. This analysis may be performed based on customers that earn income from the one or more gig economy platforms. As more user profiles are obtained, the user profiles may provide an indication of how the gig economy platform is performing and whether the earnings are growing for everyone or only for a subset of users. In other words, are the earnings of the gig economy platform uniformly distributed amongst the users or are they concentrated amongst the top performers? The first machine learning model may be a convolutional neural network, a recurrent neural network, a recursive neural network, a long short-term memory (LSTM), a gated recurrent unit (GRU), an unsupervised pre-trained network, a space invariant artificial neural network, or any equivalent thereof. In some examples, the first machine learning model may be an existing machine learning model. In further examples, the first machine learning model may be a proprietary model. Additionally or alternatively, the first machine learning model may be a modified existing machine learning model such that the first machine learning model becomes proprietary. In some instances, the first machine learning model may be trained using different parameters, such as back propagation, transfer learning, stochastic gradient descent, learning rate decay, dropout, max pooling, batch normalization, long short-term memory, skip-gram, and/or any equivalent deep learning technique.

After one or more trends have been identified, the computing device may calculate an earning potential for the user, in step 435. The earning potential calculation may be based on one or more of the user's employment information, including their earnings (e.g., income), their hours worked, and/or the user's competitiveness rating (e.g., ranking). Additionally or alternatively, the user's earning potential may be based on one or more trends associated with the gig economy platform. For example, if the gig economy platform is trending toward growth, the user may have a higher earning potential than a gig economy platform that is stagnant or shrinking. In some examples, the computing device may determine whether there are any external factors that may impact a user's earning potential via the gig economy platform. For instance, the computing device may determine whether one or more laws limit the user's ability to earn via the gig economy platform. In this regard, certain jurisdictions may have laws that limit whether people can drive for a ride sharing service or how many people can drive for a ride sharing service in the jurisdiction. Additionally, some jurisdictions have restrictions on homeowners' participation in vacation rental marketplaces, like Airbnb. If the computing device determines that one or more laws may limit the user's ability to earn via the gig economy platform, the computing device may adjust and/or scale the user's earning potential.

In step 440, the computing device may calculate an earning durability rating for the user. The earning durability rating may be calculated, for example, based on a customer rating associated with the user. The earning durability rating may be determined using a second machine learning model. Like the first machine learning model, the second machine learning model may be trained to calculate an earning durability rating based, in part, on the user's customer rating. The earning durability rating may indicate the user's potential to continue earning what the user has previously earned. The second machine learning model may be any one of the machine learning models discussed above with respect to the first machine learning model. Additionally, the second machine learning model may be trained using any of the techniques discussed above.

The computing device may determine an aggregate score, in step 445. The aggregate score may be based on the earning potential and/or the earning durability rating. In some examples, the aggregate score may be a credit score or a credit worthiness score. The aggregate score may be calculated, for example, based on the relative competitiveness, earning potential rating, and/or earning durability rating of the user as compared to a pool of similarly situated gig economy workers. The pool of similarly situated gig economy workers may have worked for the same, or similar, gig economy platform(s). Additionally, the pool of similarly situated gig economy workers may have comparable competitiveness ratings, earning potential ratings, and/or earning durability ratings.

In step 450, the computing device may determine whether the aggregate score satisfies a threshold. If the aggregate score satisfies the threshold, the computing device may send a response to the request for the financial product indicating that the request has been approved, in step 455. For example, the response may comprise an offer for the requested financial product. Additionally or alternatively, the response may comprise a line of credit. If the aggregate score does not satisfy the threshold, the computing device may send a response to the request for the financial product indicating that the request has been denied, in step 460. For denied customers, the computing device may offer the user the option t continue monitoring their data and/or information associated with the one or more gig economy platforms. In this regard, the computing device may dynamically reassess the user's earning potential and/or competitiveness for future earning potential. The computing device may periodically re-evaluate the user's earning potential and/or earning durability and determine an updated aggregate score. If the user's updated aggregate score satisfies the threshold, the computing device may subsequently offer the requested financial product to the user. Additionally or alternatively, the computing device may continue to monitor users' who were previously approved for financial products. If a user's updated aggregate score fails to satisfy the threshold (after previously satisfying the threshold), the computing device may dynamically adjust the user's financial product, for example, by reducing the user's line of credit.

The above-described systems, devices, and methods may improve the speed and/or accuracy with which information from one or more gig economy platforms may be added to a user's information. Additionally, the systems, devices, and methods described herein may improve creditworthiness predictions for gig economy workers by combining data and/or information from one or more gig economy platforms, including, for example, reviews and ratings, past/future booking patterns, earnings versus competition from the same geo-location, with historical income data and FICO information to predict a user's future earnings. Finally, the data aggregator may remove redundant, superfluous, and/or incorrect information stored in the user information, thereby reducing the amount of memory consumed by the user information.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like, that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

What is claimed is:

1. A method comprising:
receiving, by a first device and from a second device, credentials associated with one or more gig economy platforms for which a user works, wherein the credentials comprise a username and password;
sending, to the one or more gig economy platforms, the credentials;
obtaining, based on successful verification of the credentials, a stream from the one or more gig economy platforms, wherein the stream comprises profile information corresponding to the user;
parsing the profile information to obtain personal information associated with the user and employment information associated with the user;
analyzing, using automated analysis, the employment information associated with the user to determine a customer rating associated with the user;
calculating, using a machine learning model and based on the customer rating, an earning durability rating for the user;
adding the employment information and the earning durability rating to a user profile associated with the user; and
generating, based on the employment information and the earning durability rating, one or more services that the user is eligible to receive.

2. The method of claim 1, wherein the employment information comprises at least one of a name, an address, an income, hours worked, employment history, competitiveness of the user, or a customer rating of the user.

3. The method of claim 2, wherein the competitiveness of the user comprises a rating of how the user performs compared to other users within a geographic area.

4. The method of claim 1, wherein the one or more gig economy platforms comprise at least one of: a ride sharing service; a food delivery service; a pet sitting service; a personal shopper service, a courier delivery service; a moving service; a task completion service; or a cleaning service.

5. The method of claim 1, further comprising:
normalizing the stream prior to parsing the profile information.

6. The method of claim 1, wherein the automated analysis comprises at least one of: natural language processing (NLP); object character recognition (OCR); computer vision; or machine learning.

7. The method of claim 1, further comprising:
receiving a request for a financial product from the user;
sending, to the one or more gig economy platforms, the credentials;
obtaining, based on successful verification of the credentials, a second stream from the one or more gig economy platforms;
analyzing, using the automated analysis, the second stream to obtain updated employment information;
determining, using a second machine learning model, one or more trends associated with the one or more gig economy platforms;
calculating, based on the updated employment information, an earning potential for the user;
calculating, using the machine learning model and based on an updated customer rating received in the updated employment information, an updated earning durability rating for the user;
determining, based on the earning potential and the updated earning durability rating, an aggregate score; and
sending, based on a determination that the aggregate score satisfies a threshold, a response to the request for the financial product, wherein the response comprises an offer with the requested financial product.

8. The method of claim 7, wherein the one or more trends comprise consumer spend data associated with the one or more gig economy platforms.

9. The method of claim 7, wherein the one or more trends indicate at least one of growth, stagnation, or shrinkage for the one or more gig economy platforms.

10. The method of claim 7, further comprising:
obtaining a third stream, wherein the third stream comprises driving information associated with the user; and
determining the aggregate score further based on the third stream.

11. The method of claim 7, further comprising:
receiving, by the first device from a third device, a second request for a financial product;
obtaining a third stream;
calculating a second earning potential for a second user associated with the third device;
calculating a second earning durability rating for the second user associated with the third device;
determining, based on the second earning potential and the second earning durability rating, a second aggregate score; and
sending, based on a determination that the second aggregate score does not satisfy the threshold, a response to the second request for the financial product, wherein the second response comprises a denial of the second request for the financial product.

12. The method of claim 11, further comprising:
continuously monitoring the second stream;
updating, based on the monitoring the second stream, the second aggregate score; and
offering, by the first device to the third device and based on a determination that the second updated aggregate score satisfies the threshold, the financial product associated with the second request.

13. A first computing device comprising:
one or more processors; and
memory storing instructions, that when executed by the one or more processors, cause the first computing device to:
receive, from a second computing device, credentials associated with one or more gig economy platforms for which a user works, wherein the credentials comprise a username and password;
send, to the one or more gig economy platforms, the credentials;
obtain, based on successful verification of the credentials, a stream from the one or more gig economy platforms, wherein the stream comprises profile information corresponding to the user;
analyze, using automated analysis, the profile information to obtain employment information associated with the user;
add the employment information to a user profile associated with the user;
parse the profile information to obtain personal information associated with the user and employment information associated with the user;
analyze, using automated analysis, the employment information associated with the user to determine a customer rating associated with the user;
calculate, using a machine learning model and based on the customer rating, an earning durability rating for the user;
add the employment information and the earning durability rating to a user profile associated with the user; and
generate, based on the employment information and the earning durability rating, one or more services that the user is eligible to receive.

14. The first computing device of claim 13, wherein the instructions, when executed by the one or more processors, cause the first computing device to:
receive a request for a financial product from the user;
send, to the one or more gig economy platforms, the credentials;
obtain, based on successful verification of the credentials, a second stream from the one or more gig economy platforms;
analyze, using the automated analysis, the second stream to obtain updated employment information;
determine, using a second machine learning model, one or more trends associated with the one or more gig economy platforms;
calculate, based on the updated employment information, an earning potential for the user;
calculate, using the machine learning model and based on an updated customer rating received in the updated employment information, an updated earning durability rating for the user;
determine, based on the earning potential and the updated earning durability rating, an aggregate score; and
send, based on a determination that the aggregate score satisfies a threshold, a response to the request for the financial product, wherein the response comprises an offer with the requested financial product.

15. The first computing device of claim 14, wherein the instructions, when executed by the one or more processors, cause the first computing device to:
determine whether one or more laws limit the user's ability to earn via at least one of the one or more gig economy platforms; and
scale, based on a determination that one or more laws limit the user's ability to earn via the at least one of the one or more gig economy platforms, the earning potential.

16. The first computing device of claim 14, wherein the earning durability is further based on a competitiveness of the user, wherein the competitiveness of the user comprises a rating of how the user performs compared to other users within a geographic area.

17. A non-transitory computer-readable medium storing instructions that, when executed, configure a first computing device to:
receive, from a second computing device, credentials associated with one or more gig economy platforms for which a user works, wherein the credentials comprise a username and password;
send, to the one or more gig economy platforms, the credentials;
obtain, based on successful verification of the credentials, a stream from the one or more gig economy platforms, wherein the stream comprises profile information corresponding to the user;
parse the profile information to obtain personal information associated with the user and employment information associated with the user;
analyze, using automated analysis, the employment information associated with the user to determine a customer rating associated with the user;
calculate, using a machine learning model and based on the customer rating, an earning durability rating for the user;
add the employment information and the earning durability rating to a user profile associated with the user; and
generate, based on the employment information and the earning durability rating, one or more services that the user is eligible to receive.

18. The non-transitory computer-readable medium of claim 17, wherein the instructions, when executed, configure the first computing device to:
receive a request for a financial product from the user;
send, to the one or more gig economy platforms, the credentials;
obtain, based on successful verification of the credentials, a second stream from the one or more gig economy platforms;
analyze, using the automated analysis, the second stream to obtain updated employment information;
determine, using a second machine learning model, one or more trends associated with the one or more gig economy platforms;
calculate, based on the updated employment information, an earning potential for the user;
calculate, using the machine learning model and based on an updated customer rating received in the updated employment information, an updated earning durability rating for the user;
determine, based on the earning potential and the updated earning durability rating, an aggregate score; and
send, based on a determination that the aggregate score satisfies a threshold, a response to the request for the financial product, wherein the response comprises an offer with the requested financial product.

19. The non-transitory computer-readable medium of claim 18, wherein the instructions, when executed, configure the first computing device to:
determine whether one or more laws limit the user's ability to earn via at least one of the one or more gig economy platforms; and
scale, based on a determination that one or more laws limit the user's ability to earn via the at least one of the one or more gig economy platforms, the earning potential.

20. The non-transitory computer-readable medium of claim 18, wherein the earning durability is further based on a competitiveness of the user, wherein the competitiveness of the user comprises a rating of how the user performs compared to other users within a geographic area.
